(19) United States
(12) Patent Application Publication
(10) Pub. No.: US 2025/0178717 A1
(43) Pub. Date: Jun. 5, 2025

(54) CONTROL UNIT, SYSTEM AND METHOD

(71) Applicant: Liebherr-Aerospace Lindenberg GmbH, Lindenberg (DE)

(72) Inventors: Christian KOHLÖFFEL, Amtzell (DE); Werner MANGLER, Leutkirch (CN)

(21) Appl. No.: 18/951,263

(22) Filed: Nov. 18, 2024

(30) Foreign Application Priority Data
Dec. 5, 2023 (DE) 10 2023 133 936.2

(51) Int. Cl. B64C 13/48; B64C 9/08; B64C 13/50

(52) U.S. Cl. CPC B64C 13/48; B64C 9/08; B64C 13/50

(57) ABSTRACT

The present disclosure relates to a control unit for actuating at least two components of an aircraft, comprising a control part and a switching part, wherein the control part and the switching part are configured such that the components can be actuated sequentially, wherein at one timepoint just one of the components can be actuated, or that at least two components cannot be actuated simultaneously.

### CROSS REFERENCE TO RELATED APPLICATION

The present application claims priority to German Patent Application No. 10 2023 133 936.2 filed on Dec. 5, 2023. The entire contents of the above-listed application are hereby incorporated by reference for all purposes.

### TECHNICAL FIELD

The present disclosure relates to a control unit for actuating at least two components of an aircraft, comprising a control part and a switching part.

### BACKGROUND

It is known that mechanical uplift aids for extending the velocity spectrum of the aircraft are present or used on an aircraft, in particular on an aeroplane. Mechanical uplift aids are for example flaps, in particular slats and landing flaps, which can be configured in different constructions. Actuating these flaps makes it possible for the uplift to be specially adjusted to the respectively prevailing requirements, in the starting and landing phase of the aircraft. Extending these flaps leads to an increase in the wing surface area or the curvature of the wing profile, and thus allows sufficient uplift generation in a low velocity range, or allows for higher angles of attack of the wing or airfoil. Landing flaps are typically extended to the rear, from the bottom of the wing. The slats are typically extended to the front, from the wing.

### SUMMARY

In the case of use of leading edge flaps, as is the case e.g. in the Boeing 747, not all the leading edge flaps may be extended simultaneously, since unfavourable flow ratios up to flow stalling can occur in the course of all the leading edge flaps passing simultaneously from the fully retracted to the fully extended position. Therefore, e.g. the Boeing 747 comprises individual flap drives, which are electrically synchronised and pneumatically operated, as follows for example from NASA-CR-4746, 1996.

In the case of newer wing configurations, into which the incident flow is also laminar or hybrid laminar, similar problems are encountered. In contrast with the Boeing 747, the trend in newer aeroplanes is to use electrically driven flaps or also to furthermore use hydraulically and electronically actuated and controlled flaps.

According to the prior art, flaps of a mechanical uplift aid are e.g. pneumatically, hydraulically or also electrically driven. The prior art in the case of electrically or also hydraulically driven flaps is such that at least one power and/or signal electronics, for example in the form of a motor controller or a motion control engine (MCE) or a control valve block, is present or installed per flap or per drive station of a flap, and these are in each case permanently connected to a motor and/or hydraulic actuator in each case. Each motor or each actuator thus has its own power and/or signal electronics and/or its own control valve block.

The disadvantages of the prior art consist inter alia in that one power and/or signal electronics or one control valve block is required for each driven motor or for each hydraulic actuator, and thus a high number of power and/or signal electronics or control valve blocks, in particular in a leading edge flap system, is required, since one power and/or signal electronics or one control valve block can in each case actuate just one motor or one hydraulic actuator.

Against this background, the object of the present disclosure is that of providing a control unit which is improved compared with the prior art.

This object is achieved by the subject matter as described herein.

According thereto, it is provided according to the disclosure that the control part and the switching part are configured such that the components can be actuated sequentially, wherein at one timepoint just one of the components can be actuated, or in that at least two components cannot be actuated simultaneously.

Alternatively or in addition, it can optionally be provided that at one timepoint a plurality of and/or not all the components can be actuated and/or just one or a plurality of the components cannot be actuated by the control unit.

“Actuate” is optionally to be understood to mean that an electrical, pneumatic and/or hydraulic signal and/or power flow flows from the control unit and/or the control part to the component. Actuate optionally also includes driving.

The term “control” is optionally to be understood broadly and includes for example “control” and “regulate”.

It is optionally provided that in principle all components can be actuated by the control unit and/or the control part, wherein in each case at one timepoint one of the components can be actuated and all or at least one of the other components cannot.

The control unit, the control part and/or the switching part can optionally form one unit, i.e. for example be arranged on a circuit board.

The term “electric(al)” optionally includes electric(al) and/or electronic.

Optionally a sequential movement of flaps, in particular of slats and/or landing flaps, takes place, in particular by means of the control unit.

It is optionally provided that the control unit is an electrical, pneumatic and/or hydraulic control unit and/or comprises or constitutes a control valve block and/or power and/or signal electronics.

It is optionally provided that the control part is an electrical, pneumatic and/or hydraulic control part and/or comprises or constitutes a pneumatic and/or hydraulic valve and/or a power output stage.

It is optionally provided that the switching part is an electrical, pneumatic and/or hydraulic switching part and/or comprises or constitutes a changeover valve and/or an electric switch and/or commutator.

It is optionally provided that one, a plurality of or all of the components comprise or constitute an electrical, pneumatic and/or hydraulic drive, in particular in each case for moving an actuator and/or a flap of the aircraft.

The drive can be an electric, pneumatic and/or hydraulic motor, or an electric, pneumatic and/or hydraulic actuator, for example a linear actuator.

The drive can optionally be driven electrically, pneumatically and/or hydraulically. The actuation of an electric motor optionally takes place by means of power and/or signal electronics. The actuation of a hydraulic actuator optionally takes place by means of a control valve block, wherein in particular an evaluation part in the form of signal electronics can be used. The evaluation part can be or comprise signal electronics.

The power and/or signal electronics or the control valve block can optionally actuate a plurality of motors or hydraulic actuators sequentially, wherein leading edge flaps, i.e. the flaps of a leading edge, can be extended and/or retracted sequentially. The flap is optionally a leading edge flap.

It is optionally provided that the control unit comprises an evaluation part, wherein the evaluation part is optionally configured such that sensor signals of one, a plurality of or all of the components can be received and/or evaluated, wherein at one timepoint only sensor signals of one of the components can be received and/or evaluated using the evaluation part, or in that at least sensor signals of two components cannot be received and/or evaluated simultaneously.

It is optionally provided that the control unit comprises a central controller, wherein the central controller is configured so as to actuate the control part and/or the switching part.

It is optionally provided that the control unit in each case comprises a plurality of, in particular in each case two, control parts and/or switching parts.

The disclosure also relates to a system comprising a plurality of components of an aircraft and a control unit according to the disclosure.

The system optionally comprises leading edge flaps and is optionally a “leading edge system”. The system optionally does not comprise power and/or signal electronics or a control valve block per flap or actuator. A flap can be moved by means of one or more actuators, which can in turn be driven by one or more drives. The system optionally comprises power and/or signal electronics or a control valve block, by means of which a plurality of flaps and/or actuators can be driven one after the other, i.e. sequentially.

The disclosure also relates to a method, in particular using a control unit according to the disclosure, comprising the step of:
sequentially actuating components of an aircraft by means of fewer control units than components actuated by the control units, and optionally by means of exactly one control unit.

Optionally a sequential actuation of individual drives and/or flaps, in particular leading edge flaps, takes place. There is optionally no simultaneous movement of all the leading edge flaps or sequential movement of the leading edge flaps.

Advantageously, a reduced number of power and/or signal electronics or valve block components compared with the prior art can be used, by using a switching part or a commutator, in order to actuate individual flaps sequentially.

It is conceivable that two or more flaps and/or actuators are or can be actuated or driven simultaneously, but that at least two or more flaps and/or actuators are not or cannot be actuated or driven simultaneously.

By reducing the number of required power and/or signal electronics or control valve blocks compared with the prior art, in particular to the minimum required number for actuators and/or flap pairs that are to be moved simultaneously, the following advantages can be achieved:
reduced weight;
reduced costs;
increased availability;
reduction of installation space.

Optionally a sequential actuation of a plurality of drives takes place, by means of power and/or signal electronics which comprises a switching part, for example switchable components.

Optionally, the components of the power and/or signal electronics are in each case present just once in the power and/or signal electronics and are used sequentially, in order to drive or actuate similar drives.

Optionally, the components of the control valve block are in each case present just once in the control valve block and are used sequentially, in order to drive or actuate hydraulic actuators.

Optionally the evaluation part, e.g. signal electronics evaluation, is present just once and is used sequentially, in order to evaluate a plurality of sensors of similar drives.

It is noted at this point that the terms “a” and “an” do not necessarily refer to exactly one of the elements, even if this represents a possible embodiment, but rather can also denote a plurality of the elements. Likewise, the use of the plural also includes the presence of the element in question in the singular and, vice versa, the singular also includes a plurality of the elements in question. Furthermore, all the features of the disclosure described herein can be combined with one another as desired or claimed in isolation from one another.

### BRIEF DESCRIPTION OF THE FIGURES

Further advantages, features and effects of the present disclosure emerge from the following description of preferred embodiments with reference to the figures, in which identical or similar parts are denoted by the same reference signs. In the figures:

FIG. 1: is a schematic view of an embodiment of a system according to the disclosure.

FIG. 2: is a schematic view of an embodiment of a system according to the disclosure.

FIG. 3: is a schematic view of an embodiment of a system according to the disclosure.

### DETAILED DESCRIPTION

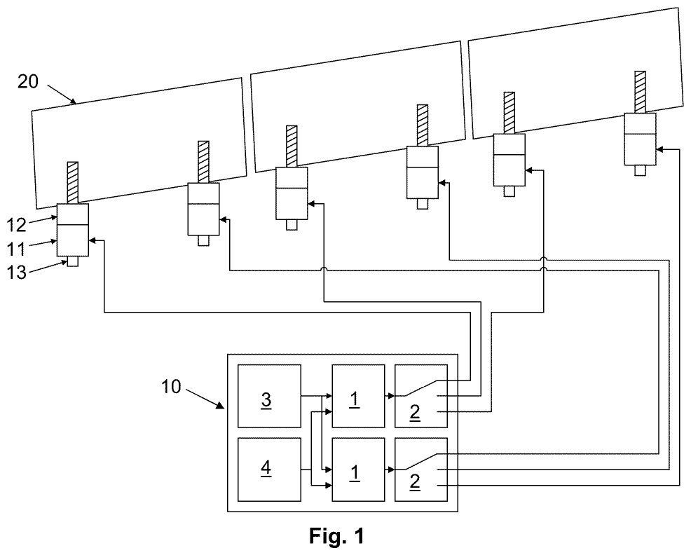

FIG. 1 shows a system comprising a control unit 10 and a plurality of flaps 20, wherein the flaps 20 may be leading edge flaps.

The control unit 10 comprises two control parts 1 in the form of power output stages, and two switching parts 2 in the form of electrical switches. The control unit 10 comprises a central controller 3 and an evaluation part 4.

The control parts 1 and/or the switching parts 2 are actuated or can be actuated by the central controller 3.

Two drive stations, each having a motor 11, a brake 12 and sensors 13, are arranged on each flap 20. These drive stations drive the flap and move it.

As can be seen from the connecting lines between the motors 11 and the switching parts 2, one power output stage 1 can in each case actuate one motor 11 of a drive station of a flap 20, and the other power output stage 1 can in each case actuate the other motor 11 of the other drive station of the same flap 20. In this case, depending on the switching position of the switching parts 2, at one timepoint just one motor can be actuated by one power output stage 1. Optionally only those switching positions of the switching parts 2 are possible that allow only motors 11 of one flap 20 to be actuated at one timepoint. This allows sequential actuation of the flaps 20 and prevents simultaneous actuation of at least two flaps 20.

For extending or retracting the flaps 20, the control parts 1 and/or the switching parts 2 switch in such a way that the flaps extend and retract sequentially, i.e. one after the other.

The system from FIG. 1 comprises individual station drives, i.e. one drive per drive station.

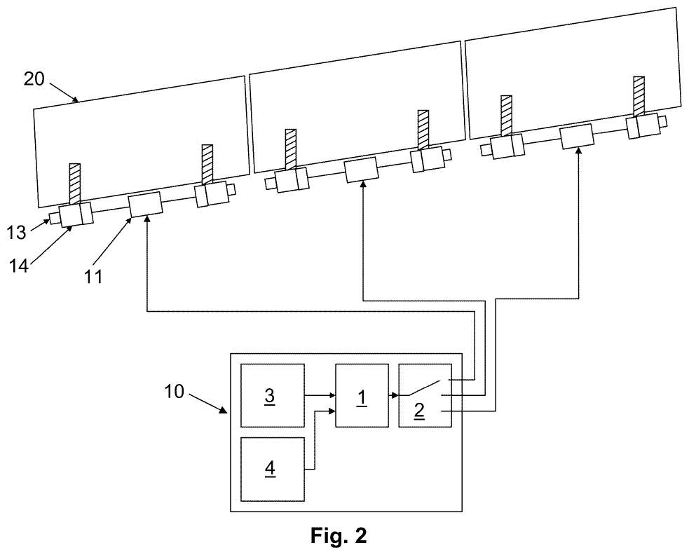

FIG. 2 shows a system comprising a control unit 10 and a plurality of flaps 20, wherein the flaps 20 may be leading edge flaps.

The control unit 10 comprises a control part 1 in the form of a power output stage, and a switching part 2 in the form of an electrical switch. The control unit 10 comprises a central controller 3 and an evaluation part 4.

The control part 1 and/or the switching part 2 are actuated or can be actuated by the central controller 3.

Two actuators 14, each having sensors 13, are arranged on each flap 20. These actuators 14 drive the flap and move it. The actuators 14 are driven by a motor 11. Thus, one motor 11 and two actuators 14 are provided per flap 20.

As can be seen from the connecting lines between the motors 11 and the switching part 2, the power output stage 1 can in each case actuate one motor 11 of one flap 20. In this case, depending on the switching position of the switching part 2, at one timepoint just one motor can be actuated by the power output stage 1. This allows sequential actuation of the flaps 20 and prevents simultaneous actuation of at least two flaps 20.

For extending or retracting the flaps 20, the control part 1 and/or the switching part 2 switch in such a way that the flaps extend and retract sequentially, i.e. one after the other.

The system from FIG. 2 comprises flap station drives, i.e. one drive per flap.

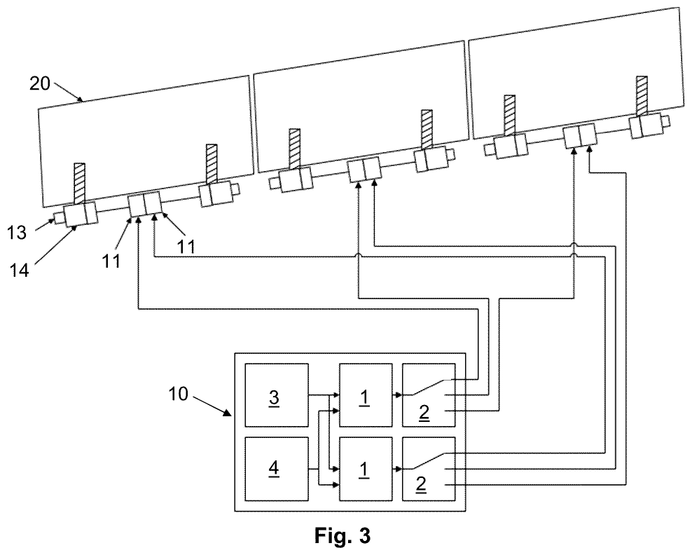

FIG. 3 shows a system comprising a control unit 10 and a plurality of flaps 20, wherein the flaps 20 may be leading edge flaps.

The control unit 10 comprises two control parts 1 in the form of power output stages, and two switching parts 2 in the form of electrical switches. The control unit 10 comprises a central controller 3 and an evaluation part 4.

The control parts 1 and/or the switching parts 2 are actuated or can be actuated by the central controller 3.

Two actuators 14, each having sensors 13, are arranged on each flap 20. These actuators 14 drive the flap and move it. The actuators 14 are driven by a motor 11, wherein two motors 11 for driving the actuators 14 are provided on each flap. Thus, two motors 11 and two actuators 14 are provided per flap 20.

The system is configured in a redundant manner, by way of the two motors 11 per flap 20 and the two control parts 1 and switching parts 2 in each case.

As can be seen from the connecting lines between the motors 11 and the switching parts 2, each power output stage 1 can in each case actuate one motor 11 of one flap 20. In this case, depending on the switching position of a switching part 2, at one timepoint just one motor 11 can be actuated by one power output stage 1. In this case, those switching positions of the switching parts 2 that allow motors 11 of different flaps 20 to be actuated by the two control parts 1 at one timepoint are also possible. Sequential actuation of the flaps 20 is made possible, and simultaneous actuation of all the flaps 20 is prevented.

For extending or retracting the flaps 20, the control parts 1 and/or the switching parts 2 switch in such a way that the flaps extend and retract sequentially, i.e. one after the other.

The system from FIG. 3 comprises redundant individual flap drives, i.e. two identically functioning drives per flap.

The system can, in particular depending on the requirements with respect to the reliability of the system and also the architecture, be equipped with a plurality of motion control engines (MCE) or power output stages.

It is conceivable that all the power output stages are integrated in a housing and are actuated by a common controller.

In this case the power output stages, as well as the sensors of the motors required for these, are configured such that they can be connected to different motors by means of a switching part or electric switch. A power output stage is therefore capable of actuating different motors sequentially.

It is conceivable that only parts of the necessary wiring are used together, and parts of the power output stage of an MCE, such as current sensors, power limit switch, brake actuation means, etc. are present multiple times per motor to be actuated.

The mentioned principles can equally be transferred to hydraulic systems. It is conceivable that in the case of a hydraulic system e.g. parts of the necessary sensors, such as pressure sensors or also electrohydraulic servo valves (EHSV) are saved by using simple changeover valves. Likewise, the simultaneous evaluation of all the sensors is not required in the case of sequentially operated drives, and an evaluation part in the form of evaluation electronics can also be switched.

The use of one signal and/or power electronics or one control valve block which actuates the plurality of drives sequentially leads to an optimisation of the system weight, a reduction in the system costs, reduced use of resources, increased system availability, and less installation space is required on the aeroplane side.

1. Control unit for actuating at least two components of an aircraft, comprising a control part and a switching part, wherein the control part and the switching part are configured such that the components can be actuated sequentially, wherein at one timepoint just one of the components can be actuated, or in that at least two components cannot be actuated simultaneously.

2. Control unit according to claim 1, wherein the control unit is an electrical, pneumatic and/or hydraulic control unit and/or comprises or constitutes a control valve block and/or power and/or signal electronics.

3. Control unit according to claim 2, wherein the control part is an electrical, pneumatic and/or hydraulic control part and/or comprises or constitutes a pneumatic and/or hydraulic valve and/or a power output stage.

4. Control unit according to claim 1, wherein the switching part is an electrical, pneumatic and/or hydraulic switching part and/or comprises or constitutes a changeover valve and/or an electric switch and/or commutator.

5. Control unit according to claim 1, wherein one, a plurality of or all of the components comprise or constitute an electric, pneumatic and/or hydraulic drive.

6. Control unit according to claim 1, wherein the control unit comprises an evaluation part, wherein the evaluation part is configured such that sensor signals of one, a plurality of or all of the components can be received and/or evaluated, wherein at one timepoint only sensor signals of one of the components can be received and/or evaluated using the evaluation part, or in that at least sensor signals of two components cannot be received and/or evaluated simultaneously.

7. Control unit according to claim 1, wherein the control unit comprises a central controller, wherein the central controller is configured so as to actuate the control part and/or the switching part.

8. Control unit according to claim 1, wherein the control unit in each case comprises a plurality of control parts and/or switching parts.

9. System comprising a plurality of components of an aircraft and a control unit according to claim 1.

10. Method, using a control unit according to claim 1, comprising the step of:
sequentially actuating components of an aircraft by means of fewer control units than actuated components.

11. Control unit according to claim 5, wherein the electric, pneumatic and/or hydraulic drive is in each case for moving an actuator and/or a flap of the aircraft.

12. Control unit according to claim 6, wherein the control unit in each case comprises in each case two control parts and/or switching parts.

13. Method according to claim 10, wherein few control units than actuated components is exactly one control unit.
